(19) United States
(12) Patent Application Publication
(10) Pub. No.: US 2005/0004997 A1
(43) Pub. Date: Jan. 6, 2005

(54) Progressive downloading of timed multimedia content

(75) Inventors: Selim S. Balcisoy, Erenkoy Istanbul (TR); Marta Karczewicz, Irving, TX (US); Tolga K. Capin, Fort Worth, TX (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/865,670

(22) Filed: Jun. 9, 2004

Related U.S. Application Data
(60) Provisional application No. 60/484,507, filed on Jul. 1, 2003.

(51) Int. Cl. G06F 15/16

(52) U.S. Cl. 709/219

(57) ABSTRACT

In progressive downloading of multimedia content, such as SVG files, the client buffers some data for a certain time so the content can be decoded and presented in a timely manner. In order for the client to start presenting the content of a file at an appropriate time, the client has to estimate the start-up delay time correctly. The server, prior to or at the time of sending the data, provides the client information indicative of content properties, such as the size and content presentation time of some or all scenes. The information may include transmission minimum bandwidth to ensure each remaining scene will be available before its presentation time. The client estimates the start-up delay time based on the provided information. Furthermore, the client can determine when to remove one or more files from its data buffer in order to minimize the memory usage.

This application is based on and claims priority to a pending U.S. provisional application Ser. No. 60/484,507, filed Jul. 1, 2003.

### FIELD OF THE INVENTION

The present invention relates generally to downloading of files and, more specifically, to start-up delay in progressive downloading.

### BACKGROUND OF THE INVENTION

In progressive downloading of multimedia content, the client usually buffers some data for a certain time so that decoding of the content can be carried out properly and in a timely manner. If the client starts playing the content too early, some parts of the content may still be downloaded when they should already be played. On the other hand, if the client starts playing the content very late or the start-up delay is very long, the client needs an unnecessarily large buffer to store the already downloaded files. It is desirable to minimize the start-up delay so that the client can begin playing the content before the downloading of the entire file is finalized.

Let us use files that contain the Scalable Vector Graphics (SVG) as an example. SVG is a language for describing two-dimensional graphics in XML (eXtensible Markup Language), which allows for three types of graphic objects: vector graphic shapes, images and text (see Scalable Vector Graphics 1.1 Specification, W3C Recommendation, 14 Jan. 2003). Graphic objects can be grouped, transformed and composed from previously rendered objects. SVG drawings can be interactive and dynamic and can also be used in animation. SVG content can be arranged in groups such that each of them can be processed and displayed independently from the following groups (groups delivered later in time). Groups are referred to hereafter as scenes. To each scene we can assign a content presentation time (or content start time) inferred from the content at which its presentation should start with relation to other scenes.

When the client downloads an SVG file stored on a server, the file is received at a given bit rate depending on the bandwidth available between the client and the server and is stored in the client's buffer. When the desired start-up delay is reached, the client starts displaying the content of the file. Start-up delay is the difference between the beginning of the file download and the start of the file's content presentation.

It has been realized that while it is desirable to minimize the start-up delay such that the client can begin playing the content before the downloading of the entire file is finalized, the start-up delay has to be sufficient to ensure that each scene is received before its player presentation time.

Currently, the start-up delay for use in conjunction with vector graphics is estimated based on the size of the file and its duration (playing time) that can be inferred from information, such as file length, frame rate and frame count given at the beginning of the file. However, in many instances, the client cannot estimate accurately the start-up delay for content such as SVG based only on this information.

Thus, it is advantageous and desirable to provide a method and a mechanism to allow the client to estimate the start-up delay correctly in order to minimize the memory usage. Furthermore, it is advantageous that the client knows which parts of the file can be discarded after presenting them so as to further minimize the memory usage.

### SUMMARY OF THE INVENTION

The present invention provides a method for progressive downloading of timed content, wherein a table that specifies the properties for the scenes in the content is provided by the server so as to allow the client to compute the appropriate start-up delay. The table may list the size, start time and minimum transmission rate for each scene. Additionally, the end time for each scene may be given in order to save memory.

Thus, according to the first aspect of the present invention, there is provided a method of signaling in a network, the network having a least a client, and a server for transmitting to the client data having a plurality of components, the components having various content properties, so as to allow the client to download the data in a client buffer before presenting at least a part of the data, each component having a component size. The method comprises:
conveying to the client information indicative of the content properties of the components; and
determining in the client, responsive to the information, a start-up delay in the presentation based on the content properties of the components.

The information may be indicative of the content presentation times of the components and further indicative of content end times of the components.

The method further comprises the step of presenting the components at player start times of the components based on the start-up delay and the content presentation times of the components.

The information may be further indicative of content end times of the components, and the method further comprises the step of removing a portion of the data after presenting said portion of the data based on the content start times and the content end times of the components.

The information may be indicative of the component sizes.

The information is conveyed to the client prior to the downloading of the data.

The information may be indicative of minimum bandwidths for the components based on the transmission rate.

The content properties comprise content presentation times of the components and content end times of the components, and the method further comprises: presenting the components at player start times of the components based on the component size and the content presentation times of the components; and removing one or more components after presenting said one or more components based on the content presentation times and the content end time of said one or more components while presenting other components in the data.

According to the second aspect of the present invention, there is provided a multimedia system, which comprises:
at least a client having a data buffer, and
at least a server for transmitting to the client data having a plurality of components, the components having various content properties so as to allow the client to download the data in the data buffer before presenting at least a part of the data, each component has a component size,
the server comprising:
   means for determining the content presentation times of the components based on the component sizes and the content properties of the components; and
   means for conveying to the client information indicative of the presentation times of the components, and
the client comprising:
   means for receiving the conveyed information; and
   means for determining a start-up delay in the presentation based on the received information.

The client further comprises
means for presenting the data according to player start times of the components based on the start-up delay and the content presentation times of the components.

The conveyed information is further indicative of content end times of the components and the client is adapted to
removing one or more components after presenting said one or more components based on the content presentation times of the components and the content end times of the components.

The information may be indicative of minimum bandwidths in transmitting the components based on the transmission rate, and the client is adapted to removing one or more components after presenting said one or more components based on the content presentation times and the minimum bandwidths of the components.

According to the third aspect of the present invention, there is provided a server in a multimedia network, the network having at least a client, the server is adapted to transmit to the client data having a plurality of components, the components having various content properties, so as to allow the client to download the data in a client buffer before presenting at least a part of the data, each component having a component size. The server comprises:
means for determining the content presentation times of the components based on the component sizes and the content properties of the files; and
means for conveying to the client information indicative of the presentation times so as to allow the client to determine a start up delay in the presentation based on the information.

According to the fourth aspect of the present invention, there is provided a client in the multimedia network, the network having at least a server for transmitting to the client data having a plurality of components, the components having various content properties so as to allow the client to download the data before presenting at least a part of the data, each component having a component size, wherein the server further transmits to the client information indicative of the content properties of the components. The client comprises:
a buffer for storing at least part of the data; and
means, responsive to the information, for determining a start up delay in the presentation based on the content properties of the components.

According to the fifth aspect of the present invention, there is provided a computer program for use in a server in a network, the network having at least a client, wherein the server is adapted to transmit to the client data having various content properties, so as to allow the client to download the data in a client buffer before presenting at least a part of the data, each component having a component size. The computer program comprises:
a first code to determine the presentation times based on the component size and the content properties of the files; and
a second code to generate information indicative of the presentation times, so as to allow the client to determine a start up delay in the presentation.

According to the sixth aspect of the present invention, there is provided a computer program for use in a client in a network, the network having at least a server for transmitting to the client data having various content properties, so as to allow the client to download the data in a client buffer before presenting at least a part of the data, each component having a component size, wherein the server is adapted to transmit to the client information indicative of the content properties. The computer program comprises:
a code to determine a start up delay in the presentation; and
a code to determine player start times of the components based on the content properties and the start-up delay in the presentation.

The present invention will become apparent upon reading the description taken in conjunction with FIGS. 1 and 2.

### BRIEF DESCRIPTION OF THE DRAWING

FIG. 1 is a block diagram illustrating a network system having a server and a client, wherein the client has a software program for determining the start-up delay, according to the present invention.

FIG. 2 is a flowchart illustrating the method for determining the start-up delay at a client, according to the present invention.

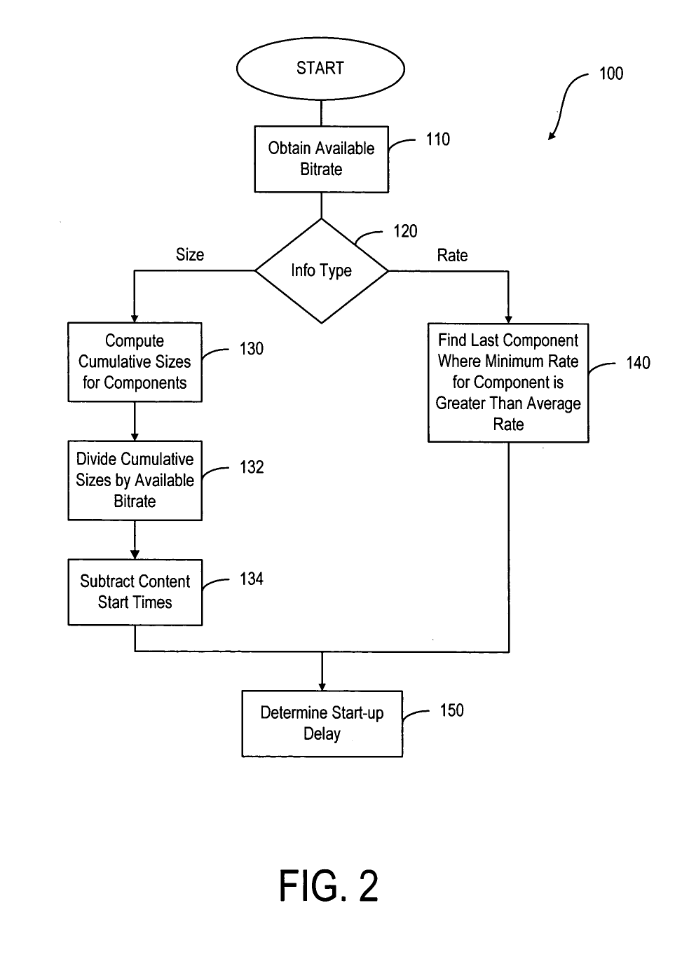

### DETAILED DESCRIPTION OF THE INVENTION

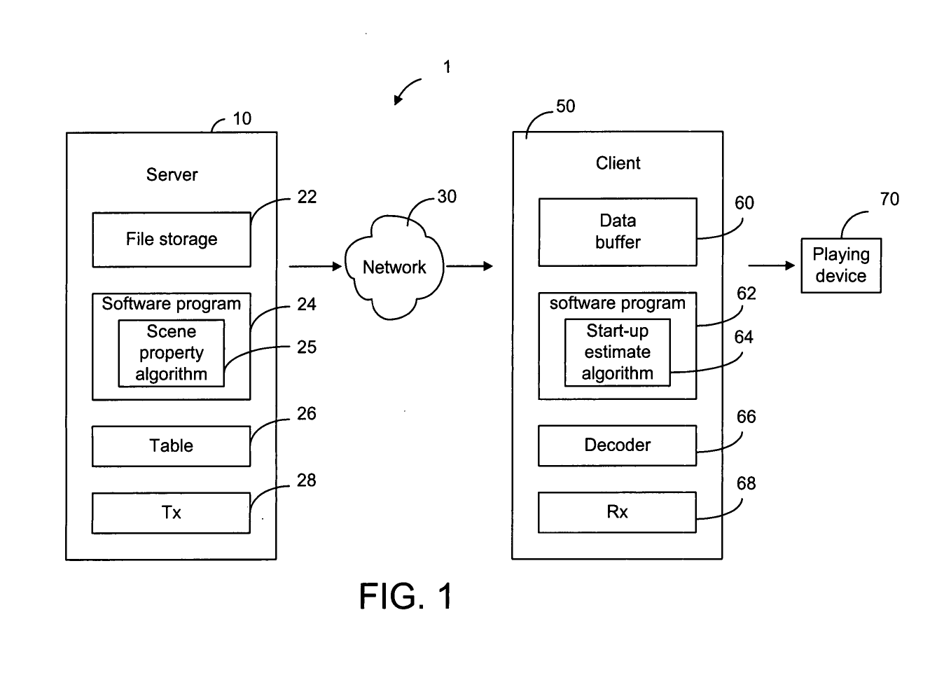

FIG. 1 shows a network system 1 having a multimedia server 10 and a multimedia client 50. The server 10 is used to send encoded data to the client 50 through a network 30 so that the client 50 can decode the data for playing on a playing device 70.

The server 10 has data storage 22 for storing files to be transmitted to the client 50 via a transmitter 28. The server 10 also has a software program 24 having executable codes for generating a table 26 listing the properties of the scenes in the files, so as to allow the client 50 to estimate the start-up delay. For example, the software program 24 includes a scene property algorithm 25 for carrying out said listing.

The client 50 has a data buffer 60 for storing the files downloaded via a receiver 68 from the server 10 for a certain time so that the content of the downloaded files can be decoded by the decoder 66 and played on the playing device 70 properly. In order to minimize the memory usage, the client 50 has a software program 62 having executable codes for computing the appropriate start up delay and player start time. For example, the software program 62 includes an algorithm 64 for computing the start up delay time. The computer program 62 also comprises other executable codes for computing the player start time and for determining when to remove one or more components in the data buffer 60 after the components have be presented.

Let us consider the following example. The size of the SVG file is equal to 175 kbits and its duration is 9 sec. The file contains an animation presentation comprising 7 scenes as listed in Table I. Table I lists the size after compression and the content start time for each scene. It should be noted that the presentation of scene 4 starts at the same time as scene 5. This means that the file for scene 4 may include only the definition of elements used in the three following scenes: scenes 5, 6 and 7. In that respect, the properties of one or more scenes in the content may be different from the other scenes. Due to the difference in properties, the files may not be presented in a sequential manner in reference to the order in which the files are downloaded.

In assigning the content presentation times, it is initially assumed that start-up delay is equal to 0. Client then calculates the values of the start-up delay and the player start time (player presentation time) by offsetting the content start time for each scene by the start-up delay. For example, if the start-up delay is equal to 2 sec, the player start time for the scene 1 is equal to 2 sec instead of 0 as listed in the table.

TABLE I

| Scene | Compressed size | |
|---|---|---|
| number | [kbits] | Content start time [s] |
| 1 | 20 | 0 |
| 2 | 20 | 1 |
| 3 | 20 | 2 |
| 4 | 100 | 3 |
| 5 | 5 | 3 |
| 6 | 5 | 5 |
| 7 | 5 | 7 |

In order to minimize the start-up delay, the client can begin playing the content before downloading the entire file is finalized. However, the start-up delay has to be sufficient to ensure that each scene is received before its player presentation time. For example, let us assume the available bandwidth is equal to 20 kbits/sec when the file as described in Table I is downloaded. If the client decides to start playing the content after receiving the first scene (scene 1), the start-up delay is equal to 1 sec. Accordingly, the player start time for scene 5 is equal to 4 sec when taking into account the start-up delay of 1 sec. With the available bandwidth of 20 kbits/sec, the file for scene 5 will be completely downloaded after 8.25 sec (165 [kbits]/20 [kbits/sec]), or 4.25 sec after it should be presented at t=4 sec. Obviously, it is impossible to present a scene before it is downloaded. Thus, it is necessary for the client to start play the content at a later time.

To demonstrate that it is not sufficient to rely only on the knowledge of the total file size and its duration for estimating the start-up delay correctly, let us again refer to the file as describe in Table I and assume the available bandwidth of 20 kbits/sec. As mentioned earlier, the size of the entire SVG file is 175 kbits and its duration is 9 sec. It requires 8.75 sec (175 [kbits]/20 [kbits/sec]) for the file to be fully received. Thus, the required time to receive is less than the duration. However, if the client decides to start presentation of the file content immediately after receiving the first scene, based on his knowledge of the total file size and its duration, scene 5 will not be received in time, as demonstrated earlier.

According to the present invention, the table 26 lists the size and content presentation time of some or all scenes, as shown in Table II. The client 50 will receive the scene properties prior to receiving the actual content of the scenes (data).

TABLE II

Size (Scene 1)
Content Presentation Time (Scene 1)
Size (Scene 2)
Content Presentation Time (Scene 2)
.
.
.
Size (Scene n)
Content Presentation Time (Scene n)
Data (Scene 1)
Data (Scene 2)
.
.
.
Data (Scene n)

Alternatively, the scene information as listed in table 26 includes minimum bandwidth Bₘ (minimum rate) in transmission to ensure that each remaining scene will be available before its player presentation time—in case the client decides to start the presentation of the entire file after the reception of this scene. If the estimated bandwidth is equal to B, the client can start playing the content of the file after receiving the scene for which the minimum rate value Bₘ is larger than B. Minimum rates for all the scenes do not have to be included at the beginning of the file. It is sufficient if the minimum rate for each scene is received together with that scene. The structure of the file is in this case is as follows:

TABLE III

Minimum Rate (Scene 1)
Minimum Rate (Scene 2)
.
.
.
Minimum Rate (Scene n)
Data (Scene 1)
Data (Scene 2)
.
.
.
Data (Scene n)

For the file as described in Table I, the minimum rates rounded up to the nearest kbits/sec are as follows:

| | |
|---|---|
| Scene 1: | 49 |
| Scene 2: | 42 |
| Scene 3: | 35 |
| Scene 4: | 3 |
| Scene 5: | 2 |
| Scene 6: | 1 |

Accordingly, if the estimated bandwidth is equal to 20 kbits/sec the client can start the presentation of the file after receiving scene 4, to which the assigned value of minimum rate in transmission is equal to 3 kbits/sec.

In order to compute the minimum rate for each scene, the software program 24 may have the following pseudo code:

```
scene_size={20, 20, 20, 100, 5, 5, 5};
content_start_time={0, 1, 2, 3, 3, 5, 7};
number_of_scenes=7;
for (i=1; i<number_of_scenes; i++){
    cumulative_size[i−1]=0;
    for (j=i; j<number of scenes; j++){
        cumulative_size[j]=cumulative_size[j−
      _1]+scene_size[j];
    }
    minimum_rate[i−1]=0;
    for (j=i; j< number_of_scenes; j++){
        rate=cumulative_size[j]/content_start_time[j];
      _if (rate>minimum_rate[i−1]){
          minimum_rate[i−1]=rate;
        }
    }
}
```

It should be noted that not all the scenes in the SVG file will have their end times explicitly specified. For example, the file scene 4 as described in Table I can simply be a definition of elements used in following scenes. Thus, in order to provide a hint to the client as to how long each scene should be kept in the memory, the content end time for each scene may also be signaled to the client 50. Using the scene examples from Table I, the content start time and the content end time are listed in Table IV. As can be seen in Table IV, all the scenes with the exception of scene 4 can be discarded immediately after they are presented.

TABLE IV

| Scene | | Content end time |
|---|---|---|
| number | Content start time [s] | [s] |
| 1 | 0 | 1 |
| 2 | 1 | 2 |
| 3 | 2 | 3 |
| 4 | 3 | 9 |
| 5 | 3 | 5 |
| 6 | 5 | 7 |
| 7 | 7 | 9 |

Alternatively we can specify that a given scene should be kept until the arrival and display of scene number m. For example, scene 1 has to be kept until the end of its own presentation, i.e., m=1. Scene 4 has to be kept until the end of the presentation of scene 7, i.e., m=7. Each of the other scenes has also to be kept until the end of its own presentation.

In sum, the signal method for use in the client to determine the start-up delay can be based on the sizes and the content presentation times of the data components or the minimum rate in transmission of the data components. As shown in the flowchart 100, the client obtains available bitrate or bandwidth at step 110. At step 120, it is determined whether the information received from the server contains the size of the data components or the minimum bandwidth. If the information is indicative of the size of the data components, the client computes cumulative sizes for components at step 130 and divides the cumulative sizes, at step 132, by the available bitrate as obtained step 110 in order to obtain the “cumulative play times”. The client subtracts the content start time, at step 134, from the cumulative play times for determining the start-up delay at step 150. Alternatively, if the minimum bandwidths for the data components are available from the information conveyed by the server, the client finds first component where minimum rate for component is greater than the average rate, at step 140, in order to determine the start-up delay at step 150.

Furthermore, when the content end time for each scene is provided to the client, the client can further minimize the memory usage by selectively discarding the scenes in the SVG files based on the provided information.

Although the invention has been described with respect to a preferred embodiment thereof, it will be understood by those skilled in the art that the foregoing and various other changes, omissions and deviations in the form and detail thereof may be made without departing from the scope of this invention.

1. A method of signaling in a network, the network having a least a client, and a server for transmitting to the client data having a plurality of components, the components having various content properties, so as to allow the client to download the data in a client buffer before presenting at least a part of the data, each component having a component size, said method comprising:
conveying to the client information indicative of the content properties of the components; and
determining in the client, responsive to the information, a start-up delay in the presentation based on the content properties of the components.

2. The method of claim 1, wherein the information is indicative of the content presentation times of the components.

3. The method of claim 1, wherein the information is indicative of the component sizes.

4. The method of claim 1, wherein the information is conveyed to the client prior to the downloading of the data.

5. The method of claim 2, wherein the information is further indicative of content end times of the components.

6. The method of claim 2, further comprising:
presenting the components at player start times of the components based on the start-up delay and the content presentation times of the components.

7. The method of claim 6, wherein the information is further indicative of content end times of the components, said method further comprising:
removing a portion of the data after presenting said portion of the data based on the content start times and the content end times of the components.

8. The method of claim 1, wherein the data is transmitted at a transmission rate in the network, and the information is indicative of the transmission rate.

9. The method of claim 1, wherein the data is transmitted at a transmission rate in the network, and the information is indicative of minimum bandwidths for the components based on the transmission rate.

10. The method of claim 1, wherein the content properties comprise content presentation times of the components and content end times of the components, said method further comprising:
presenting the components at player start times of the components based on the component size and the content presentation times of the components; and
removing one or more components after presenting said one or more components based on the content presentation times and the content end time of said one or more components while presenting other components in the data.

11. A multimedia system comprising:
at least a client having a data buffer, and
at least a server for transmitting to the client data having a plurality of components, the components having various content properties so as to allow the client to download the data in the data buffer before presenting at least a part of the data, each component has a component size, wherein
the server comprises:
means for determining the content presentation times of the components based on the content properties of the components; and
means for conveying to the client information indicative of the presentation times of the components and
the client comprises:
means for receiving the conveyed information; and
means for determining a start-up delay in the presentation based on the received information.

12. The system of claim 11, wherein the means for determining the content presentation times is also for determining the component sizes, and
wherein the means for conveying to the client information indicative of the presentation times is also for conveying to the client information indicative of the component sizes.

13. The system of claim 11, wherein the client further comprises:
means for presenting the data according to player start times of the components based on the start-up delay and the content presentation times of the components.

14. The system of claim 13, wherein the conveyed information is further indicative of content end times of the components and the client is adapted to
removing one or more components after presenting said one or more components based on the content presentation times of the components and the content end times of the components.

15. The system of claim 11, wherein the information is conveyed to the client prior to the downloading of the data.

16. The system of claim 11, wherein the data are transmitted at a transmission rate and the information is indicative of minimum bandwidths in transmitting the components based on the transmission rate.

17. The system of claim 16, wherein the client is adapted to removing one or more components after presenting said one or more components based on the content presentation times and the minimum bandwidths of the components.

18. A server in a multimedia network, the network having at least a client, the server is adapted to transmit to the client data having a plurality of components, the components having various content properties, so as to allow the client to download the data in a client buffer before presenting at least a part of the data, each component having a component size, said server comprising:
means for determining the content presentation times of the components based on the content properties of the files; and
means for conveying to the client information indicative of the presentation times so as to allow the client to determine a start up delay in the presentation based on the information.

19. The server of claim 18, wherein the means for determining the content presentation times is also for determining the component sizes, and
wherein the means for conveying to the client information indicative of the presentation times is also for conveying to the client information indicative of the component sizes.

20. The server of claim 18, wherein the information is conveyed to the client prior to transmitting of data to the client.

21. The server of claim 18, wherein the data are transmitted at a transmission rate, and the information is indicative of minimum bandwidths in transmitting the components based on the transmission rate.

22. A client in the multimedia network, the network having at least a server for transmitting to the client data having a plurality of components, the components having various content properties so as to allow the client to download the data before presenting at least a part of the data, each component having a component size, wherein the server further transmits to the client information indicative of the content properties of the components, said client comprising:
a buffer for storing at least part of the data; and
means, responsive to the information, for determining a start up delay in the presentation based on the content properties of the components.

23. The client of claim 22, wherein the information is indicative of the content presentation times and sizes of the components, said client further comprising:
means for presenting the data according to player start times of the components based on the start-up delay and the content presentation times of the components.

24. The client of claim 23, wherein the information is further indicative of content end times of the components, and the client removes one or more components after presenting said one or more components based on the content presentation times and the content end times of the components.

25. A computer program for use in a server in a network, the network having at least a client, wherein the server is adapted to transmit to the client data having various content properties, so as to allow the client to download the data in a client buffer before presenting at least a part of the data, each component having a component size, said computer program comprising:
a first code to determine the presentation times and sizes based on the content properties of the files; and
a second code to generate information indicative of the presentation times and sizes, so as to allow the client to determine a start up delay in the presentation.

26. A computer program for use in a client in a network, the network having at least a server for transmitting to the client data having various content properties, so as to allow the client to download the data in a client buffer before presenting at least a part of the data, each component having a component size, wherein the server is adapted to transmit to the client information indicative of the content properties, said computer program comprising:
a code to determine a start up delay in the presentation; and
a code to determine player start times of the components based on the content properties and the start-up delay in the presentation.
